(19) United States
(12) Patent Application Publication
(10) Pub. No.: US 2004/0002910 A1
(43) Pub. Date: Jan. 1, 2004

(54) Financial asset management system

(76) Inventor: Shinichi Mizukami, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/324,322

(22) Filed: Dec. 20, 2002

(30) Foreign Application Priority Data
Jul. 1, 2002 (JP) P2002-192518

(51) Int. Cl. G06F 17/60

(52) U.S. Cl. 705/36

(57) ABSTRACT

Bank account transactions and fund investment are easily conducted by a customer through an investment-linked account opened with a bank, while using the bank as a sole contact point. An investment-linked account 110 includes a function to automatically transfer money exceeding an upper limit amount arbitrarily set by the customer or money reaching an accumulation target amount arbitrarily set by the customer, from the balance of the investment-linked account 110, to a fund 210 selected arbitrarily by the customer from funds offered by a fund management company 200. A system 1 includes customer information databases 331 and 332, which stores the information of bank transaction executed through the investment-linked account 110 and the information of fund transaction executed through the fund account 220 as customer information.

### BACKGROUND OF THE INVENTION

1. Field of the Invention

This invention relates to management systems of financial assets for individuals, corporations and organizations, more specifically, to a financial asset management system capable of transacting business with a number of financial institutions through an account opened with a bank.

2. Description of the Related Art

The methods of managing financial assets invested by individuals, corporations or other organizations include depositing money with a bank, and investing in a fund arbitrary selected from various funds offered by fund management companies. The funds managed by fund management companies generally include investment company type funds (mutual fund) and trust type funds.

The fund management companies for investment company type funds (mutual fund) are composed of: an investment manager; a custodian which keeps fund assets based on a custody agreement entered into with the investment manager; an investment advisory company which makes investment decisions, places orders, and the like, based on an investment advisory agreement being entered into with the investment manager; distributors including broker-dealers, banks and other financial institutions, which sell funds to customers and provide other customer services.

Meanwhile, the fund management companies for trust type funds are composed of: an investment trust management company, a trustee bank which keeps and manages the trust asset based on a trust agreement entered into with the investment trust management company; an investment advisory company which makes investment decisions, places orders, and the like, based on an investment advisory agreement entered into with the investment trust management company; distributors including broker-dealers, banks and other financial institutions, which sell funds to customers and provide other customer services.

These fund types include, but not limited to, Japanese equity, global equity, global fixed income, U.S. fixed income, and various money market funds, as well as the packages such as fund of funds, variable annuities and asset allocation programs.

Along with recent establishment of a deposit insurance cap for deposit protected by Deposit Insurance Corporation, the deposit in excess of such a deposit insurance cap is outflowing from the financial institution such as banks.

On the other hand, an investment in funds is tend to be regarded to accompany a higher risk, while a higher return is expected, and it is often difficult to estimate the range of the risk the investor is taking.

Therefore, individuals, corporations and organizations are likely to diversify their financial assets in bank deposits and fund investments more positively in the future.

### SUMMARY OF THE INVENTION

Traditionally, it is necessary to have a deposit account with a bank in order to manage cash at the bank, and it is also necessary to have a fund account with a distributor or a custodian in order to invest in funds. Accordingly, a customer who wishes to diversify assets and intends to place money at a deposit account as well as purchase funds is required to have both a deposit account with a bank and a fund account with a distributor or a custodian. In addition, when the customer wishes to transfer a part of the bank deposit to invest the funds, the customer has to transfer money from the deposit account with the bank to the fund account with a distributor or a custodian by oneself. Moreover, when the customer intends to deposit redeemed money, a dividend, or sales proceeds of the funds with the bank, the customer is required to transfer money from the fund account with the distributor or the custodian to the deposit account with the bank by oneself. Such operations incommode the customer.

In the meantime, banks, which maintain the deposit for the customer, are required to develop and offer new financial products that attract the customer, so as to prevent the disintermediation.

Meanwhile, many fund management companies have less selling power as compared to major banks. Accordingly, such fund management companies encounter a problem of less opportunity to appeal to customers and consequentially face difficulty in selling their products.

In consideration of the foregoing problems, the objective of this invention is to provide a financial asset management system, which is capable of transferring money with ease between a deposit account and a fund account through a bank as a sole contact point, by utilizing an investment-linked account set-up with the bank.

To solve the foregoing problems, the first aspect of this invention, financial asset management system, includes a server having a transfer unit configured to automatically transfer money exceeding a predetermined upper limit amount of deposit or money reaching a predetermined accumulation target amount in an account held with a bank, to purchase a fund arbitrarily selected from the funds offered by a fund management company, and a customer information storage unit connected to the server and configured to store the record of bank transaction and the record of fund transaction initiated by the transfer of money from the investment-linked account as customer information.

### BRIEF DESCRIPTION OF THE DRAWINGS

FIG. 1 is a block diagram showing an implementation of a financial asset management system according to this invention.

FIG. 2 is a block diagram of bank part

FIG. 3A is a view showing an example of customer operation page administered by the bank part.

FIG. 3B is a view showing another example of a customer operation page administered by the bank part.

FIG. 4 is a block diagram of fund part.

FIG. 5 is a view showing an example of customer operation page administered by the fund part.

FIG. 6 is a time chart showing the process among a customer, the bank part, and the fund part at the time of opening an account.

FIG. 7 is an example of a time chart for performing various operations among the customer, the investment-linked account and the fund account.

FIG. 8A is an explanatory view concerning the operations in the system.

FIG. 8B is an explanatory view that is contiguous with that of FIG. 8A.

FIG. 9 is a view of the relation between a bank-related part and a fund-related part in the system.

FIG. 10 is a view showing an implementation of the system for fund management companies that manage investment company type funds (mutual funds).

FIG. 11 is a view showing an implementation of the system for the fund management companies that manage trust type funds.

FIG. 12 is a view showing an implementation of the system including banks and fund management companies.

FIG. 13 is another view showing an implementation of the system.

### DETAILED DESCRIPTION OF THE INVENTION

An implementation of this invention will be described below with reference to the accompanying drawings.

### System Configuration

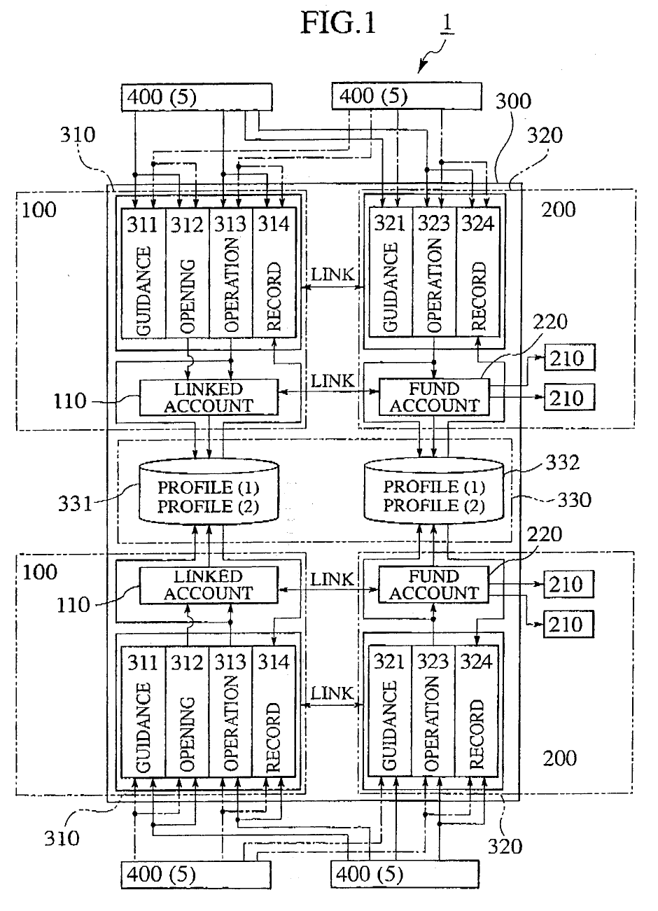

FIG. 1 is a block diagram showing an implementation of a financial asset management system 1 according to this invention. The system 1 is essentially composed of banks 100, fund management companies (which includes an investment trust management company, a trustee bank, an investment advisory company and the like in the case of a trust type fund, or includes an investment manager, a custodian, an investment advisory company and the like in the case of an investment company type fund (mutual fund)) 200, and a server 300 which interconnects the banks 100 and the fund management companies 200 with a network. The following will describe this implementation based on an assumption that the network is configured through the Internet. However, the system 1 is applicable to any other network systems including new technologies to be put to practical use in the future. For example, the network may be constructed by a wireless LAN technology. Although FIG. 1 illustrates only two banks 100 and two fund management companies 200, the system 1 can be applicable to more than two banks 100 and more than two fund management companies 200. The customers 5 can access the system 1 by use of communication terminals (such as computers connectable to the Internet or portable information communication terminals such as mobile phones) 400 connected to the network.

The server 300 administers an area (public area), which is accessible by any person through a homepage of each of the banks 100 or a homepage of each of fund management companies 200, and an area (private area) accessible with a login process only by the customer 5 who maintains an investment-linked account 110. In addition, any person can access the public area via a homepage of a system management company (not shown in FIG. 1) to the extent such access is pre-arranged with the respective banks 100 and the respective fund management companies 200.

The following will describe the details of a configuration of the server 300.

As shown in FIG. 1, the server 300 is broadly classified into a bank part 310, a fund part 320, and a customer information part 330. In addition, the server 300 includes a function to link the bank part 310 and the fund part 320, a function to perform the various operations of the investment-linked account 110 to be described below, and a data processing unit (a control unit), which is not shown in FIG. 1, configured to perform various functions to be described later.

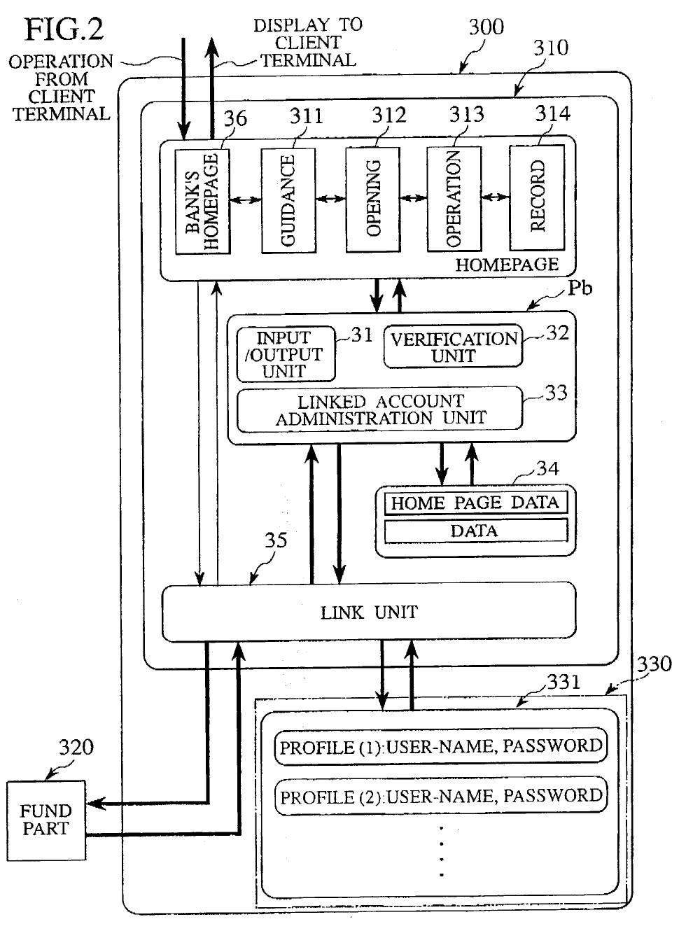

FIG. 2 is a block diagram of the bank part 310 of the server 300. The bank part 310 will be described as follows with reference to FIG. 2.

The bunk part 310 of the server 300 is essentially composed of: a data processing unit Pb including an input/output unit 31, a verification unit 32, and an investment-linked account administration unit 33, a data storage unit 34 configured to store data for a homepage; and a link unit 35 to be controlled by the data processing unit Pb to connect to the fund part 320 or to the customer information part 330.

The input/output unit 31 can receive information (information such as a user name, a password or an operative instruction) from the terminal 400, which constitutes an input tool for the customer 5. Moreover, the input/output unit 31 can also output a variety of information (such as information on a homepage) to the terminal 400 of the customer 5. In this implementation, the homepage is displayed on a display unit (such as a liquid crystal display monitor) (not shown here), which is provided separately.

The profiles of customers 5 are stored in a bank part customer information database 33). Each profile stores customer information including a user name, a password, a balance, operation history, information concerning withdrawal and deposit of money in and out of the investment-linked account 110, and the like.

The input/output unit 31 displays various pages including, a guidance page 311 for the investment-linked account 110; an opening procedure page 312 for the investment-linked account 110 which are made accessible by any person from a homepage 36 of each bank 100; a customer operation page 313 to allow a customer who has already opened the investment-linked account 110 to log in and perform various operations through one's own investment-linked account 110; a customer bank transaction record display page 314 to display a bank transaction record using the investment-linked account 110 of the customer in response to the requesting operation by the customer, and the like.

Meanwhile, the verification unit 32 verifies as to whether or not the password, the use name and other required information of the customer 5, which are inputted through the input/output unit 31, coincide with the customer information stored in advance in the bank part customer information part 331. If the customer failed to log in the customer operation page 313, a separately provided error display homepage (not shown here) should be displayed as appropriate.

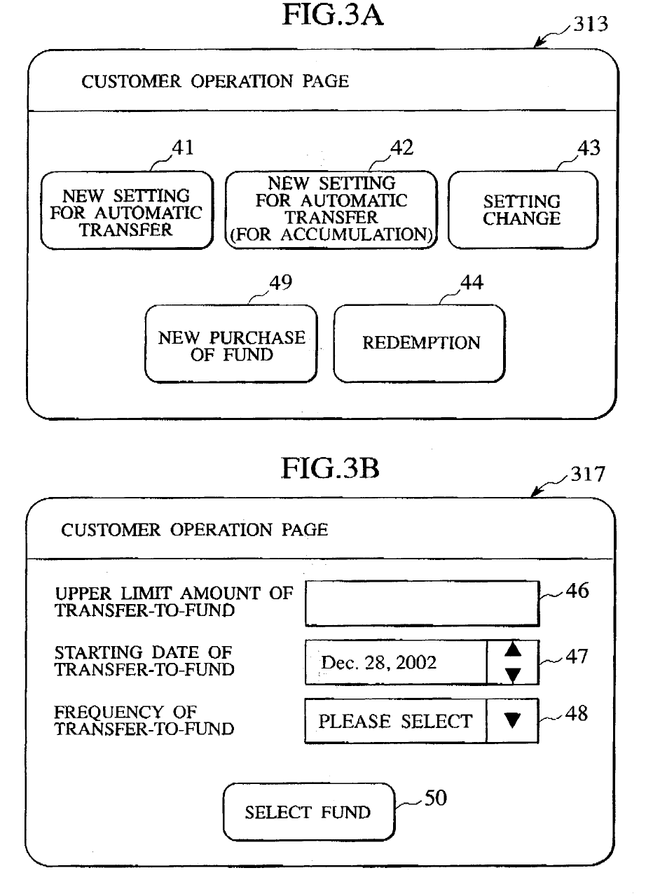

FIG. 3A shows an example of the customer operation page 331 displayed by the input/output unit 31. As shown in FIG. 3A, various buttons to be displayed on the customer operation page 313 include: a button for a new setting of automatic transfer 41 for configuring the setting so as to automatically transfer money, which exceeds an upper limit amount set arbitrarily by the customer 5, to a fund 210; a button for a new setting of automatic transfer (for accumulation) 42 for configuring the setting so as to automatically transfer money, which reaches an accumulation target amount set arbitrarily by the customer 5, to the fund 210; a setting change button 43 for changing the setting of the upper limit amount or the accumulation target amount; a redemption button 44 for redeeming a fund; a button for a new purchase of fund 49 for purchasing funds 210 apart from the automatic transfer functions; and the like.

FIG. 3B shows an example of another operation page 317 of the customer operation page 313. When the new setting for automatic transfer button 41 is selected, for example, the operation page 317 indicates an input field 46 for setting a transfer-to-fund upper limit amount, a pull-down menu 47 for setting a starting date of transfer-to-fund, a pull-down menu 48 for selecting a frequency (such as on 15th of every month, on every Friday, or everyday) of transfer-to-fund, and the like as shown in FIG. 3B. The operation page 317 is also provided with a fund selection button 50 for selecting funds 210 that is linked to a fund selection screen, which is not illustrated here.

In other words, the data processing unit Pb of the bank part 310 of the server 300 includes (1) a function (an ordinary type) to set or change a transfer-to-fund upper-limit amount, and (2) a function (an accumulation type) to set or change a transfer-to-fund target amount. In addition, although illustration is omitted therein, the data processing unit Pb also includes (3) functions same as an existing ordinary deposit account (such as deposit, withdrawal, transfer or remittance), (4) a function to withdraw money in excess of the balance of deposit account and within an overdraft limit backed by the fund invested, and the like.

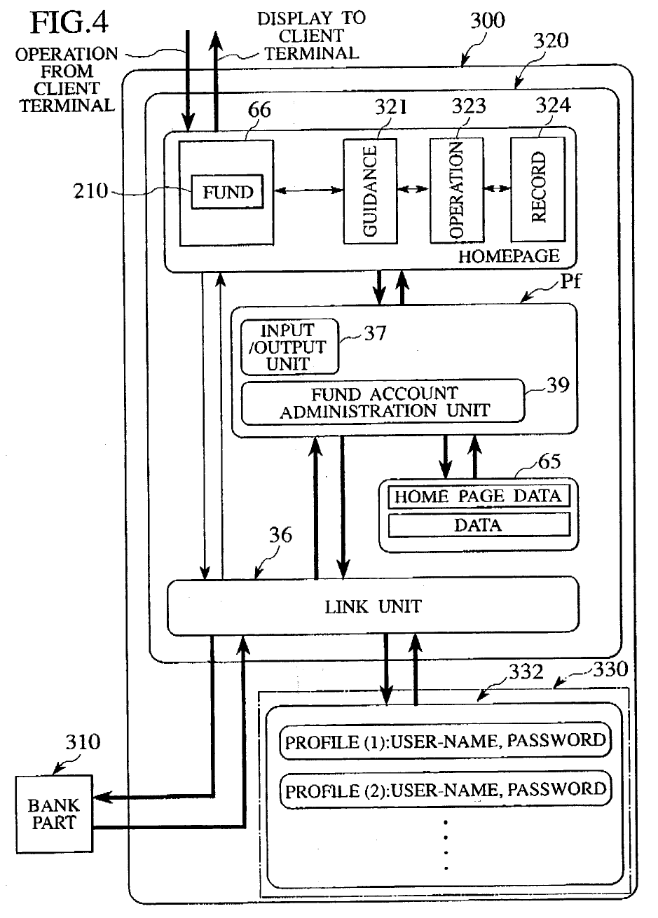

FIG. 4 shows a block diagram of the fund part 320 of the server 300. As shown in FIG. 4, the fund part 320 is essentially composed of: a data processing unit Pt including an input/output unit 37, and a fund account administration unit 39 configured to administer the fund account 220, which are to be described later; and a data storage unit 65 configured to store data for a homepage. As shown in FIGS. 1 and 4, the fund part 320 is connected to a fund part customer information database 332 via a link unit 36 so that data transfer takes place when needed. The input/output unit 37 can receive information (information such as an operational instruction) from the terminal 400, which constitutes the input tool for the customer 5. The input/output unit 37 can also output a variety of information to the terminal 400 of the customer 5. In this implementation, the homepage is displayed on the display unit (such as a liquid crystal display monitor) (not shown here), which is to be provided separately.

The profiles of the customers 5 are stored in the fund part customer information database 332. Each profile of customer information is recorded and stored based on various operations executed by the customer at the fund part 320 including, but not limited to, selection or purchase of the funds 210, in which the money exceeding the predetermined upper limit amount of the investment-linked account 110 or the predetermined accumulation target amount is to be invested.

The fund part 320 of the server 300 includes various pages such as a guidance page 321 of the various funds 210 listed on a homepage 66 of each fund management company 200; a customer operation page 323 to allow a customer logging in from the homepage 36 of the bank part 310 to perform various operations concerning the respective funds 210; a customer fund transaction record display page 324 to display a fund transaction record through the investment-linked account 110 of the customer 5 in response to the requesting operation by the customer 5.

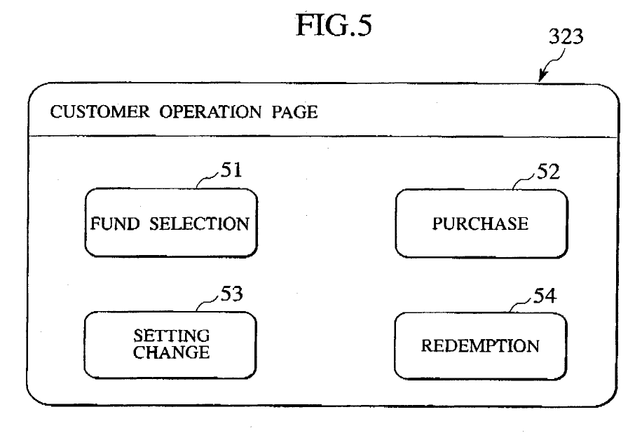

FIG. 5 shows an example of the customer operation page 323. The customer operation page 323 includes buttons to perform various operations, such as a fund selection button 51 for selecting the fund 210 that the customer 5 desires, a purchase procedure button 52, a setting change button 53 for changing the various settings, a redemption procedure button 54 for a redemption procedure, and the like.

As described above, the customer operation page 323 being administered by the fund part 320 is to be displayed to the customer 5 through the Internet when new purchase of fund button is selected from the customer operation page 313 being administered by the bank part 310. For example, when the customer select a fund 210 to be automatically invested, the customer is to select the new setting for automatic transfer button 41 of the customer operation page 313, and the customer operation page 317 will be displayed on the client terminal 400. On this page, the transfer-to-fund upper limit amount is inputted, and the starting date to transfer, the transfer frequency, and the fund 210 are selected (see FIG. 3B). When the customer 5 wishes to invest in a new fund 210 apart from the automatic transfer, the new purchase of fund button 49 of the customer operation page 313 is to be selected, then the customer operation page 323 administered by the fund part 320 is automatically displayed to the customer 5 (the client terminal 400). If the customer 5 selects the fund selection button 51, the customer 5 can select a desired fund 210 from the fund information administered by the fund part 320.

Therefore, the data processing unit Pf of the fund part 320 of the server 300 includes (1) a function to withdraw or redeem the fund, (2) a function to set or change the amount to be invested. In addition, the data processing unit Pf also includes (3) a function to retrieve information on the fund, (4) a function to retrieve information on the entire fund market, (5) a function to select or change the fund to be invested, and the like.

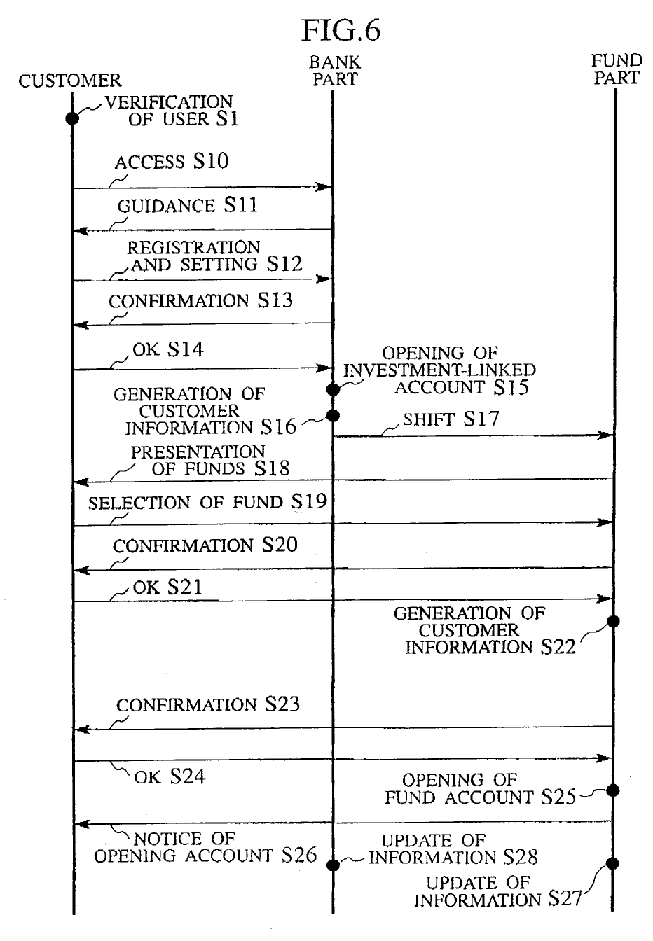

FIG. 6 is a time chart concerning operations of the bank part 100 and the fund part 200 in the system 1 when the customer 5 (the client terminal 400) opens a new investment-linked account 110. Respective steps will be described below with reference to FIG. 6.

### Opening of Account

Description will be made below regarding the opening of the account by use of the system 1. Firstly, the customer is required to complete identification and other procedures in accordance with applicable laws and regulations (Step 1) prior to opening the account by use of the system 1, and then the customer 5 is allowed to access the homepage 36 of the bank 100 to perform the respective steps described below.

If the customer 5 already possesses another account with the bank 100, then it is also possible to convert such an existing account to the investment-linked account 110 to be usable in the system 1, by performing the respective steps described below via the network or taking necessary procedures with the bank 100 either over the counter or on the telephone.

Firstly, the customer 5 accesses the homepage 36 of the bank (Step 10). Upon opening the investment-linked account 110, the customer 5 may refer to the opening guidance 311 on the homepage (Step 11), and sets up a user name, a password corresponding to the user name, and the like (Step 12). Then, confirmation is requested as to whether or not the user name, the password and the like match with the instruction of the customer 5 (Step 13), and after the confirmation by the customer 5 (Step 14), the customer 5 is allowed to proceed with subsequence steps. If the user name, the password or the like do not match with the intention of the customer 5 due to an input error or other reasons, then the process returns to Step 12 for allowing the customer 5 to input the setting again.

After these steps, the investment-linked account 110 is opened with the bank part 310 (Step 15). Moreover, customer information is created in the bank part customer information database 331 (Step 16).

When the customer 5 opens the investment-linked account 110 with the bank 100, the customer operation page 321 of the fund management company 200, which is interconnected via the network, will be displayed to the customer 5 (Step 17). Funds 210 offered by the fund management company 200 are presented on the screen of the terminal of the customer 5 by selecting the fund selection button (50 or 51) from the customer operation page 323 or 317 (Step 18) or from other appropriate pages. Note that the screen is shifted to a fund selection screen, which is not illustrated here, by selecting the fund selection button (50 or 51).

Next, the customer 5 selects one of the funds 210 (Step 19). The confirmation is requested as to whether or not the selected fund 210 matches with the intention of the customer 5 (Step 20), and if the selection is correct (Step 21), the customer 5 can proceed with subsequent steps. If the selected fund is not correct or if the customer wishes to change the selection, then the process returns to the fund selection in Step 19 again.

When the fund 210 is selected properly, customer information concerning the fund is generated in the fund part customer information database 332 (Step 22).

Then, the contents of the overall settings are to be confirmed again by the customer 5 (Step 23). If the contents of the settings are correct (Step 24), a fund account (a fund custody account) 220, which keeps beneficial interest securities or profit participating securities of the selected fund 210, is opened while being linked to the investment-linked account of the customer 5 (Step 25).

After these steps, the investment-linked account 110 and the interlinked fund account 220 are opened.

In this event, opening of the investment-linked account 110 and opening of the fund account 220 linked to the investment-linked account 110 are notified to the customer 5 again (Step 26). Along with the notice, information is updated severally at the bank 100 and at the fund management company 200 based on the operations and transactions so far (Steps 27 and 28).

Note that FIG. 6 describes the steps performed via the network while the identification process is to be done off-line separately. Such identification process may take place between Step 14 and Step 15. If the customer 5 already possesses another account with the bank 100, the customer 5 can perform all the steps for opening the investment-linked account 110 and the fund accounts 220 via the network without a requirement of off-line identification. However, in such a case, a procedure for converting the existing account to the investment-linked account 110 should be done in Step 15.

### Operation Between Accounts

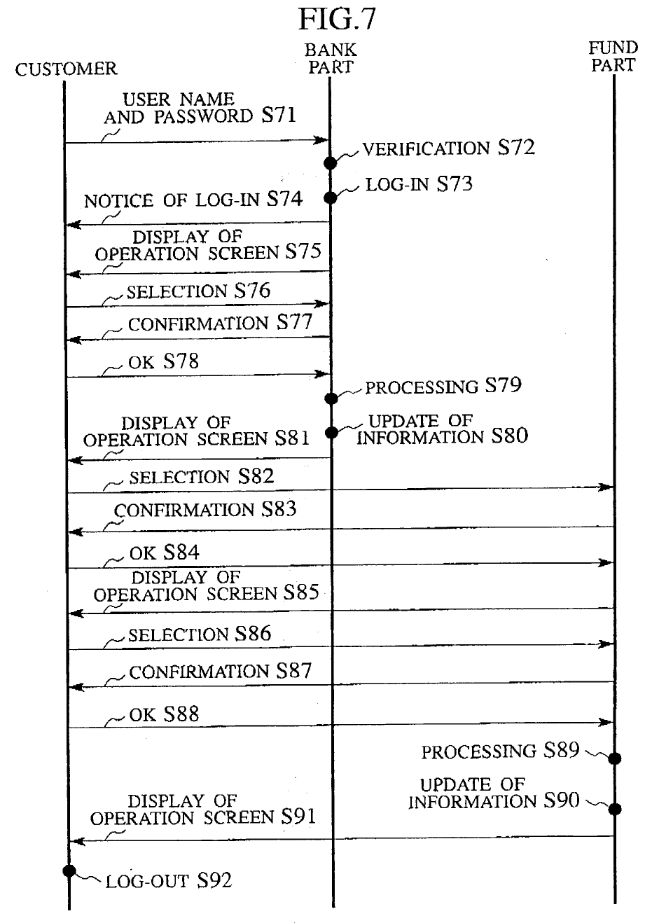

FIG. 7 is an example of a time chart for performing various operations among the customer, the investment-linked account 110 and the fund account 220.

Firstly, the customer 5 logs in the investment-linked account 110 by inputting the user name and password or the like from the terminal 400 (Step 71). The verification unit 32 verifies as to whether or not the user name and the password of the customer 5 coincide with the record of the customer information stored in advance in the bank part customer information database 331 (Step 72). When the customer 5 is verified as a qualified user, then a login operation to the system 1 is completed (Step 73).

After notifying the customer 5 that the customer 5 logged in the system 1 properly (Step 74), the input/output unit 31 displays the customer operation page 313 that is administered by the bank part 310 (Step 75). The customer selects a desirable operation button from the displayed operation page 313 (Step 76).

Subsequently, confirmation is requested as to whether or not the selection coincides with the intention of the customer 5 (Step 77 and Step 78). If the selection does not coincide with the intended operation, the process returns to Step 76 and the customer 5 selects the desirable button again.

Now, description will be made based on the assumption that the processing selected in Step 76 is to be treated in the bank part 310. Specifically, description will be made regarding the case where the setting change button 43 is selected to change the setting of the transfer upper limit amount for the selected fund 210. In this case, in Step 76, the requested process is performed in the bank part 320 and treated by the processing unit Pb (Step 79). When the processing is completed, the customer information on the customer 5 is updated (Step 80).

When all the process is completed, the customer operation page 313 is displayed again (Step 81). It is also possible to return to the homepage 36 of the bank 100.

Next, description will be made for an example where an operation, to be processed in the fund account 220, is selected from the customer operation page 313. Specifically, description will be made regarding the case where the customer 5 selects the new purchase of fund 49 to select a fund 210.

When the new purchase of fund button is selected (Step 82), confirmation is requested as to whether or not the selected processing is the one desired by the customer 5 (Step 83 and Step 84). Thereafter, the customer operation page 323 being administered by the fund part 320 is displayed (Step 85).

In this operation, the fund selection button 51 is selected so as to select a fund 210 (Step 86). Here, confirmation is requested again as to whether or not the selected processing is the one desired by the customer 5 (Step 87 and Step 88).

After confirmation, the process selected by the customer 5 is treated by the processing unit Pf (Step 89). After the processing, the customer information in the fund part customer information database 332 is also updated based on the processing (Step 90).

In Step 40, the customer operation page 313 being administered by the bank part 310 is displayed again. If the customer 5 wishes to finish the processing, the customer logs out of the system 1 by selecting a logout button, which is not illustrated here, and a series of processing is thereby terminated (Step 92).

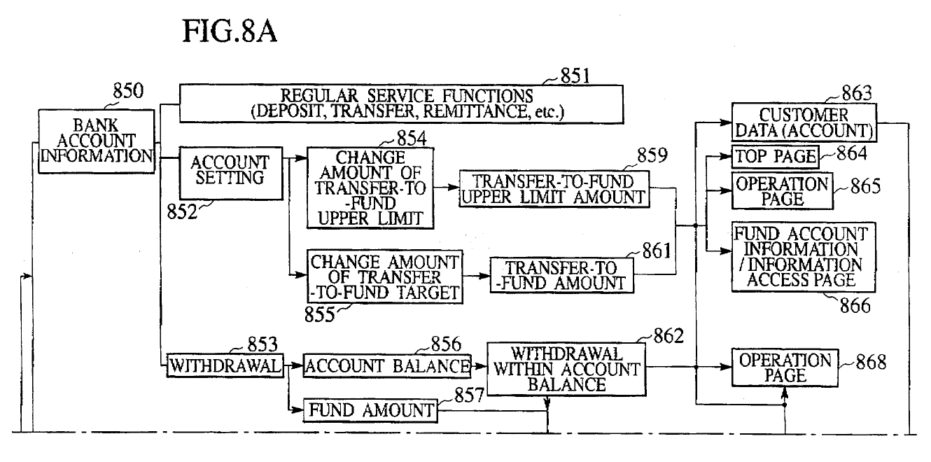

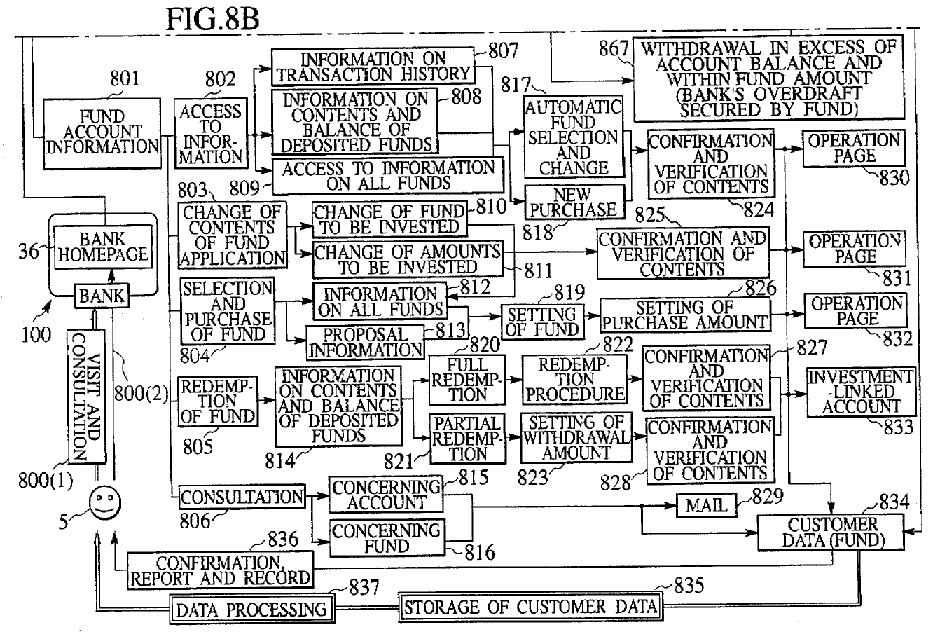

FIGS. 8A and 8B are an explanatory view showing the example of flows of operation feasible in the system 1 including the operations described in FIGS. 6 and 7.

The customer 5 accesses the bank 100. The access includes a case of accessing the homepage 36 of the bank 100 through a network (800(2)), a case of visiting an branch office of the bank 100, and a case of accessing the homepage 36 from the terminal installed in the branch office of the bank 100 (800(1)).

The customer 5 accesses bank account information or fund account information, through the accounts opened in accordance with the above-described procedures via the homepage 36 (801, 850). In the following, description will be made one by one to show the case of accessing the bank account information and the case of accessing the fund account information.

### Access to Bank Account Information

From the customer operation page 313, the customer 5 who accesses the bank account information can operate functions of depositing, money transfer and remittance same as a usual bank account (regular operational functions)(851), amendment of the account setting (852), money withdrawal (853) and the like. Description of the regular operational functions is omitted here, and other functions are described below.

The account setting (852) is one of the functions operable from the customer operation page 313, which includes the change of amount for the transfer-to-fund upper limit (854) and the change of amount for the transfer-to-fund target amount (855).

The change of the transfer-to-fund upper limit amount (854), leads to the new transfer-to-fund upper limit amount (859).

The change amount of the transfer-to-fund target (855) leads to the new amount of the transfer-to-fund target (861).

The withdrawal (853) leads to the confirmation of the account balance (856) and money is withdrawn from the balance (862). Meanwhile, when withdrawal within the overdraft amount secured by the fund (857) is performed, it is possible to withdraw money more than the balance of the investment-linked account 110 and within a limit of overdraft secured by the fund 210 as collateral (867).

When the operations concerning the bank account are completed, the screen returns to the operation page 313 or to the homepage 36 of the bank (864 or 865). However, when an operation concerning the fund 210 is performed, the operational screen may move to a page for retrieving the fund account information, or any of fund information pages provided by the fund management companies 200 or fund information provided by a fund research company 500, as the case may be (866).

Moreover, the details of the respective operations are stored in personal information database 331 for the investment-linked account 110 and in personal information database 332 for the fund account 220 (863 and 834).

### Access to Fund Account Information

When the fund account information is accessed (801), retrieval of fund information (802), changes to the contents of fund application (803), selection of the fund for purchase (804), redemption of the fund (805), and consultation regarding the selection of funds 210 (806) become feasible from the operation page 323.

On the page of retrieval of fund information (802), it is possible to retrieve information on transaction history, information on the details and the balance of the funds, and any of the fund information provided by the fund management companies 200 and the fund information 501 provided by the research company 500 (807, 808 and 809).

On the page of change of the contents of fund application (803), change of the fund 210 to be invested (801), change of the amount to be invested (811), information on all the funds (812), and retrieval of the fund information (809) for retrieving the above-mentioned fund information 501 provided by the research company 500 are feasible. Subsequent to these operations, fund selection and change for automatic transfer, and new purchase (817 and 818) are performed, and then confirmation of the operations and verification thereof are performed (824). Such verification is performed by the above-described verification unit 37. Thereafter, the screen returns to the customer operation page 313 or 323 again (803), and data updating processes are performed as the need arises.

In the selection of the fund for purchase (804), there are information of all the funds 210 offered by respective fund management companies 200, research on the funds 501 provided by research companies 500 when available (812), and a recommendation from the fund management companies 200 regarding the fund 210 which meets demands of the customer 5 when such requests are submitted by the customer 5 by inputting necessary information (813). Thereafter, the application is set for the selected fund 210 (819), and the purchase amount of the selected fund 210 is set up (826). Thereafter, the screen returns to the operation page 313 or 323, and the information on selected fund and the information on purchase amount are updated.

On the page of consultation (806), it is possible to make an inquiry concerning the fund account 220 or the funds 210 via the secured network (815 and 816). The inquiry is to be answered by a person in charge through an electronic mail, secured mailbox, or the like (829).

The results of the above-described series of operations will be reflected to the personal information database 332 for the funds (834). Moreover, such the results of the operations are also reflected to the accumulation of the customer data, data analysis, and a notice to the customer 5 (835, 836 and 837).

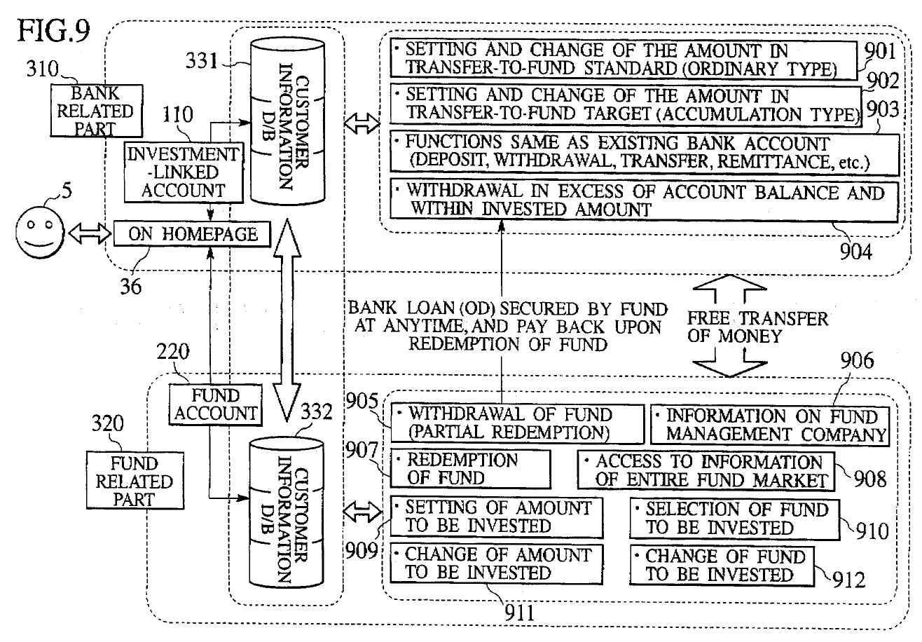

FIG. 9 is a view of the relation between a bank-related part 310 and a fund-related part 320 in the system 1. As it is described in FIG. 9, the investment-linked account 110 can be opened arbitrarily with the bank 100, which the customer 5 has business with. The investment-linked account 110 also enables the customer 5 to automatically transfer the money out of the deposit balance of the customer 5 that exceeds the upper limit amount arbitrarily set by the customer 5, or to automatically transfer the money reaching the accumulation target amount set by the customer 5, to purchase fund 210 which the customer 5 selected arbitrarily from the numerous funds 210 offered by the respective fund management companies 200 (901 and 902). Moreover, the investment-linked account 110 also enables the customer 5 to transfer an arbitrary amount within the balance of the investment-linked account 110 to the fund 210 arbitrarily selected by the customer 5 (903).

In addition, the investment-linked account 110 has a function to allow the customer 5 to arbitrarily instruct redemption or partial redemption of the fund 210 based on terms of the releveant fund 210, and a function to withdraw the money through the investment-linked account 110 (905 and 906). Furthermore, the investment-linked account 110 also has a function to withdraw the money without redeeming the fund 210 or during the period of redeeming the fund 210 (a waiting period from instruction of redemption of the fund 210 to the receipt of money), by use of an overdraft account to be set to the investment-linked account 110 by the bank 100 secured by the fund 210 or redemption amount of the fund 210 as collateral (904). As described above, the investment-linked account 110 also has the functions to retrieve the investment information (906) and the fund market information (908), to select and change the fund to be invested (910 and 912), to select and change the amount to be invested (909 and 911), and so on.

The customer 5 can actually perform all the required operations through the investment-linked account 110 opened with the bank 100, notwithstanding that the customer 5 possesses the accounts both at the bank 100 and at the fund management company 200. As described previously, the series of functions such as the transfer are provided by the server 300.

### DESCRIPTION OF EXAMPLES

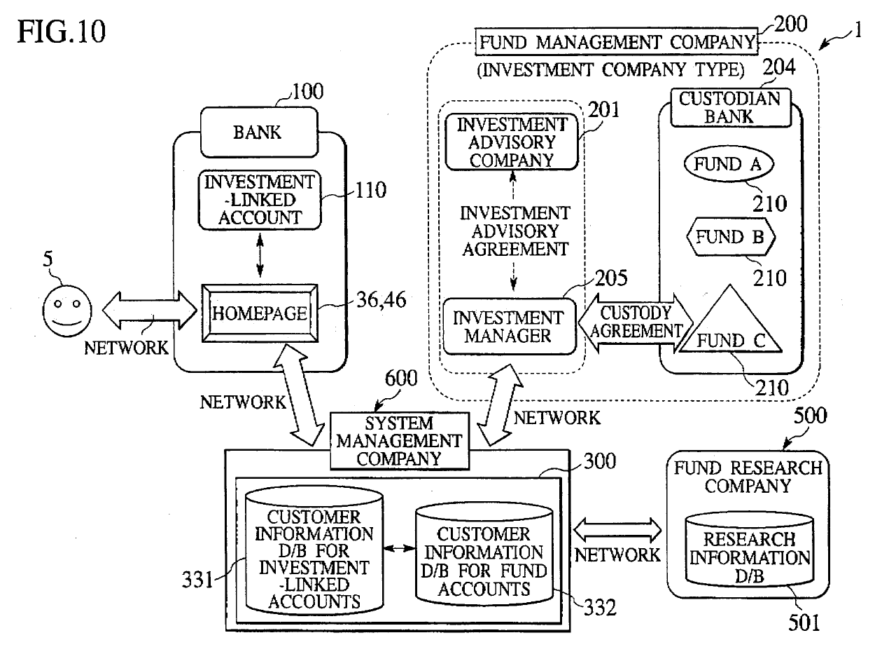

FIG. 10 to FIG. 13 are views showing the concrete implementation of the financial asset management system 1.

financial asset management system 1 has various other functions in additions to the functions described above. Description will be made regarding those additional functions with reference to FIG. 10 to FIG. 13.

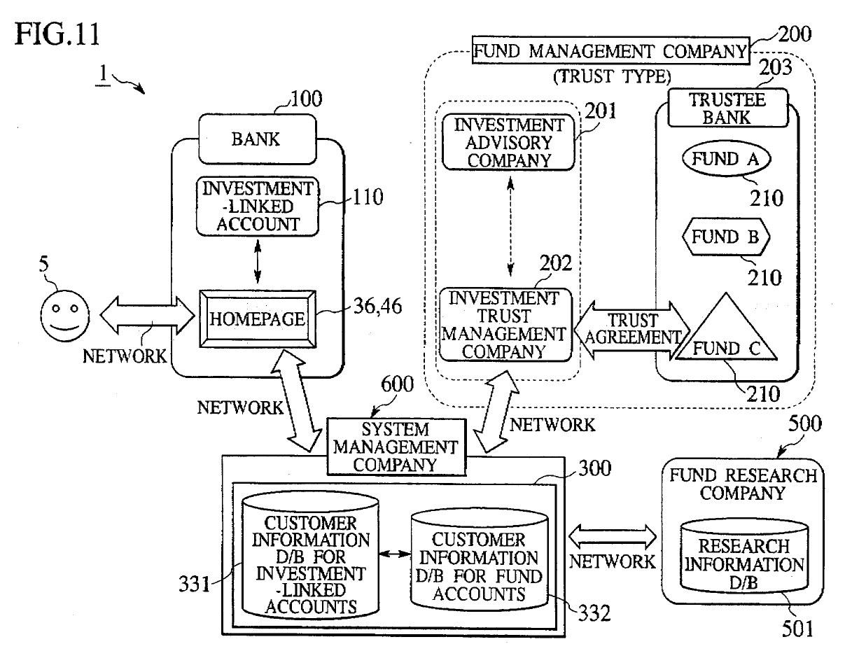

FIGS. 10 and 11 show examples using the system 1. The difference between these two examples relies on whether the fund managed by fund management companies 200 is structured as the investment company type (mutual fund) (which is managed by an investment advisory company 201, an investment manager 205, and a custodian 204) or formed as the trust type (which is managed by the investment advisory company 201, an investment trust management company 202, and a trustee bank 203). Other parts of the system 1 are similar in the both examples. In each of the examples, the customer information part 330 and the server 300 are administered by a system management company 600, so that necessary information is easily exchanged with the bank 100 and the fund management company 200 upon request. Moreover, in each of the examples, the third-party fund research company 500, which is independent of the fund management company 200 and provides the research information 501 concerning the funds 210, is also connected to the system 1 via the network. Although illustration is omitted therein, the customer 5 possesses a terminal.

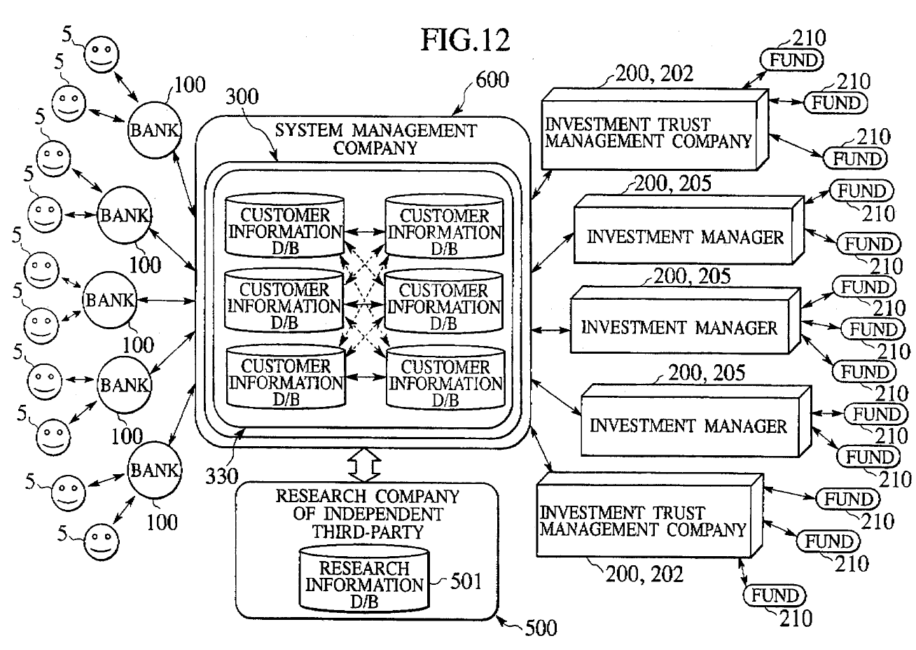

Meanwhile, FIG. 12 shows another aspect of the examples described above. As shown in FIG. 12, the system 1 is composed of customers 5, banks 100 connected to these customers 5, fund management companies 20 which manage funds 210 (fund management companies 200 composed of: an investment manager 205; an investment trust management company 202), the system management company 600 which interconnects the customers 5, the banks 100, and the fund management companies 200, and the fund research company 500. As shown in the drawing, it is needless to say that the system 1 can be structured to serve a number of customers 5, the banks 100, and the fund management companies 200.

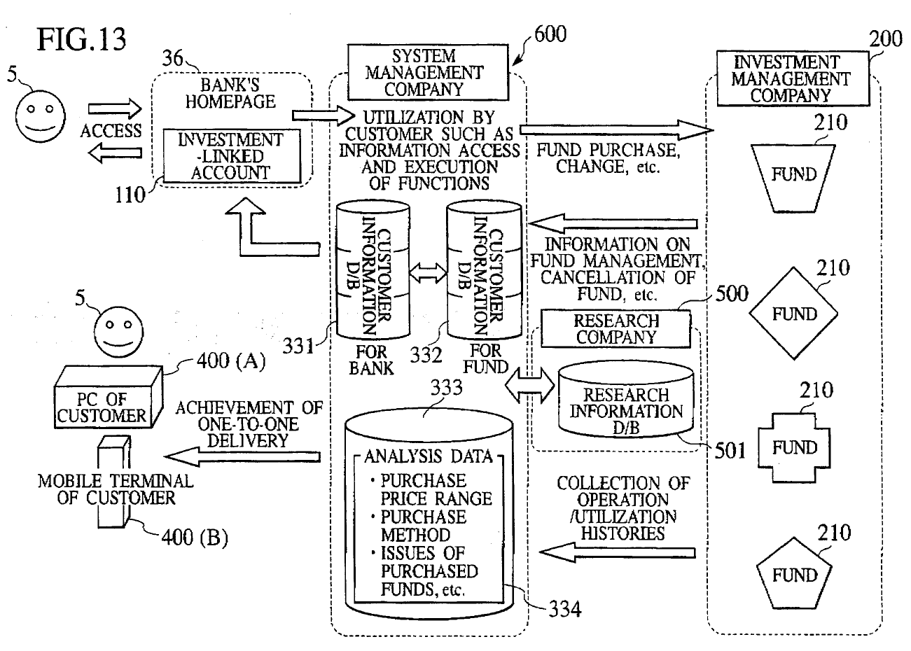

FIG. 13 shows another example, in which the same reference numbers are designated to the same components in other examples and descriptions thereof are omitted. In this example, in addition to the personal information databases 331 and 332, the system management company 600 includes an analysis data storage unit 333 in a system thereof for storing analysis data 334 specific to the customers 5, such as purchase price ranges, purchase methods or issues of purchased funds, which are analyzed from operational histories of the customers 5. Moreover, the server 300 may, if requested by the customer 5, deliver the analysis data 334, together with risk analysis and life plan recommendation, to a computer 400(A) or a portable information terminal 400(B), which constitutes a terminal for each customer 5, by use of an electronic mail, secured mailbox, or the like.

As illustrated in these examples, by opening an investment-linked account 110 with a bank 100 and by setting up either the upper limit amount of the accumulation target amount so as to transfer the money to the fund 210, it is possible to control the bank deposit balance constantly within the deposit insurance cap protected by Deposit Insurance Corporation of Japan, or within a limit arbitrarily set by the customer 5. It is also possible to have the bank 100 explain to the customer 5 the mechanism of the investment-linked account 110 thoroughly and minutely, at the time of opening the investment-linked account 110. Since the various operations can be carried out with the terminal 400 connected to the network, the customer 5 does not need to go to the bank 100 each time for setting or changing the upper limit amount or the accumulation target amount. The customer 5 can select a fund form all the funds 210 available only by opening the investment-linked account 110 with the bank 100. The investment-linked account 110 can be utilized for receiving dividends or redemption money of the funds 210. It is also possible to designate, through the customer operation page 313 administered by the bank part 310, other accounts (which can be an ordinary bank accounts) other than the investment-linked account 110 for the purpose of receiving the dividends or redemption money of the funds 210. It is also possible to utilize research prepared by an independent third-party fund research company 500. Using the information retrieved from the research company 500, it is possible to make an investment decision in the selection of funds 210 or in the selection of fund managers among numerous options based on the objective and independent fund research information.

It is also possible to select a foreign currency fund 210. When the foreign currency fund 210 is selected, foreign exchange associated with the transfer of money from the investment-linked account 110 to the fund 210 and the transfer of money from the fund 210 to the investment-linked account 110 can be dealt by applying market exchange rate automatically or by selecting an exchange rate separately arranged by the customer 5. It is also possible to open an investment-linked account 110 in a foreign currency in addition to the usual investment-linked account 110 in the home currency. In the case of opening the investment-linked account 110 in a foreign currency, foreign exchange associated with the transfer of money between the investment-linked account 110 in the foreign currency and the investment-linked account 110 or other bank account in the home currency can be dealt similarly by applying the market exchange rate automatically or by selecting an exchange rate separately arranged by the customer 5. It is possible for the customer 5 to select or change the options through the customer operation page 313 administered by the bank part 310, even though the details are not illustrated here.

In addition, it is possible to pursue higher return in real time by using the system 1. Diversification of the risk becomes easier. The customer can enjoy security, profitability and convenience with the system 1. The money is available for withdrawal at anytime for the sum of the account balance of the investment-linked account and certain proportion of the asset invested in the funds by utilizing an overdraft facility set up in accordance with an arrangement with the bank. The money transfer becomes easier. Effective and efficient cash management can be achieved by properly managing the receipt of money (eliminate the troubles concerning the availability of arriving money). The troublesome of operating a number of accounts (deposit accounts and the fund accounts) can be eliminated. It becomes possible to control the risk within the limit of certain credit ratings of the funds 210 in addition to the deposit insurance cap protected by Deposit Insurance Corporation.

Meanwhile, with the system 1, the bank 100 can provide value added cash management service to its customers, and has more opportunities for acquiring new accounts. The bank 100 can sell not only the products of an affiliated fund management company, but also the products of the non-related fund management companies 200, and the bank 100 can sell these products as its own strategic products. The bank 100 can receive commissions upon sales of the funds 210. By offering both the attractive investment and the convenience of freedom in deposit and withdrawal of money, the bank can earn fidelity of the customer to the bank. When money flows into the investment-linked account, the money exceeding a certain amount or reaching a certain amount is automatically transferred to the fund 210. Therefore, it is possible for the bank to reduce the risk of investment of money received as deposit. Moreover, it is also possible for the bank to increase foreign exchange transactions.

Meanwhile, the fund management company 200 can dramatically increase the asset under management by using the system 1. The fund management company 200 can build up trustful relations with the customers 5 by using the network through the banks 100. Relationships with a number of banks 100 can be enhanced through the network. The fund management company 200 can increase the opportunities of offering the newly developed products to more customers 5 through banks 100. The fund management companies 200 can focus on fund management activities, as they can increase the sales channels through the banks 100 via Internet without carrying out the sales promotions by themselves. Furthermore, increases in management fees can be expected.

As for the system management company 600, it can, by operating the system 1, gather and accumulate the data of respective customers 5 concerning the preference of funds 210, such as the issues of funds, price ranges, and so on, through the transaction and reference histories of the customers 5. Based on the accumulated data 333, the system management company 600 can, upon agreement with the bank 100 or the fund management company 200, perform one-to-one advertisements to the terminals 400 of the customers 5. In other words, based on the accumulated data concerning each customer 5, the system management company 600 can offer the customer 5 new products and provide product information and current market information, so as to meet the needs of the customer 5. Such improvement in customer services may increase the reliability of the customer 5 on the system and the products and the customer 5 may invest in funds 210 more actively. Since these services of the system management company 600 are to support the sales activities and customer services for the bank 100 or for the fund management company 200, these merits are also advantageous to the bank 100 and to the fund management company 200.

Moreover, along with the increase in number of participating banks 100 and fund management companies 200 in the system 1, it is possible to obtain enormous data accumulation, which are hardly obtainable only by a single bank and a single fund management company (or by a single group). Accordingly, it is possible to foster the fund market by achieving the market-wide promotion activities and customer services far beyond a feasible range attainable by just a bank and a fund management company (or by a group). Eventually, the financial market can be developed further and financial industries can increase the revenue along with such a market-wide progress.

Meanwhile, the research company 500 can provide information to more customers 5 effectively through the banks 100. Accordingly, it is possible to increases the revenue for the information services.

Smooth operation of the server 300, i.e. the financial asset management system 1, is expected be carried out by a system management company, which is independent from the bank 100 or the fund management companies 200.

The entire content of Japanese Patent Application No. P2002-1925198 with a filing date of Jul. 1, 2002 is herein incorporated by reference. Although the invention has been described above by reference to certain embodiments of the present invention, the invention is not limited to the embodiments described above and changes will occur to those skilled in the art, in light of the teachings. The scope of the invention is defined with reference to the following claims.

What is claimed is:

1. A financial asset management system comprising:
a server including a transfer unit configured to automatically transfer any of money exceeding a predetermined upper limit amount of deposited money in an opened account and money reaching a predetermined accumulation target amount, to a fund arbitrarily selected among funds offered by a fund management company; and
a customer information storage unit connected to the server and configured to store records of a bank transaction and records of a fund transaction caused by the money transferred from the account to the fund individually as customer information.

2. A financial asset management system comprising:
accounts opened with banks;
funds provided by fund management companies being connected to the accounts with a network; and
at least one server configured to link the funds of the fund management companies with the accounts of the bank by use of the network,
wherein the server automatically transfers any of money exceeding a predetermined upper limit amount of deposited money in each of the accounts and money reaching a predetermined accumulation target amount, to a fund arbitrarily selected among the funds provided by the fund management companies, and
records of a bank transaction using the account and records of a fund transaction caused by the money transferred from the account to the fund are severally recorded as customer information.

3. The financial asset management system of claim 2, wherein the server performs opening of any of the accounts by access through the network.

4. The financial asset management system of claim 2, wherein the server performs any of selection of the fund, a change of the selected fund, and setting and changing any of the upper limit amount and the accumulation target amount to be transferred to the fund.

5. The financial asset management system of claim 1, wherein the server transfers loaned money to the account, the loaned money being obtained by securing the fund originally purchased with the money transferred from the account as collateral.

6. A financial asset management system comprising:
at least one server including a controller;
at least one client terminal connected to the server and configured to operate the controller;
a first account which is opened with a bank by the client terminal, the first account being administered by the server;
a second account which is opened by the client terminal with a fund management company to provide funds, which is administered by the server, and which is interconnected to the first account via a network; and
a storage unit configured to store at least a piece of first information concerning the first account and at least a piece of second information concerning the second account,
wherein the client terminal operates the first information from the first account via the controller, and
the client terminal operates the second information via the first account.

7. The financial asset management system of claim 6, wherein the client terminal is a portable information terminal.

8. The financial asset management system of claim 6,
wherein the storage unit further includes:
a first storage unit configured to store the first information; and
a second storage unit configured to store the second information, and
wherein the server further includes:
a first server computer unit having a first account administration unit to control the first account, and the first storage unit; and
a second server computer unit having a second account administration unit to control the second account, and the second storage unit.

9. The financial asset management system of claim 8,
wherein the first server computer unit further includes:
a verification unit;
a first input/output unit configured to exchange information between the client terminal and the first server computer; and
a first link unit configured to exchange information with the second server computer unit, and
wherein data in the first storage unit and data in the second storage unit are processed by the first server computer when the verification unit verifies that information inputted via the first input/output unit coincides with verification information contained in the first information.

10. The financial asset management system of claim 8,
wherein the second server computer unit further includes:
a second input/output unit configured to exchange information between the client terminal and the server; and
a second link unit configured to exchange information with the first server computer unit,
wherein the second server computer unit retrieves information requested by a processing request being verified by the verification unit, and
the second server computer unit transmits the requested information to the first server computer unit via the second link unit.

11. The financial asset management system of claim 9,
wherein the first information at least includes first deposit information concerning money deposited in the first account, input/output history in the first account, a fund name of a selected fund, money information concerning money to be transferred to the fund, processing history information processed by the first server unit, the verification information to be used by the verification unit, and second account information to specify the second account being connected to the first account,
the second information at least includes second deposit information concerning money deposited in the second account, processing history information processed by the second server unit, fund information concerning the selected fund, and first account information to specify the first account being connected to the second account, and
the first server computer unit transfers any of money exceeding an upper limit amount stored in the first information and money reaching an accumulation target amount, out of money deposited in the first account toward the second account, based on the name of the selected fund and the money information which are included in the first information.

12. A financial asset management server comprising:
a controller;
a first account which is opened with and administered by a bank by use of the controller;
a second account which is opened with a fund management company providing funds, the second account being opened and administered by use of the controller, the second account being interconnected to the first account via a network; and
a storage unit configured to store at least a piece of first information concerning the first account and at least a piece of second information concerning the second account,
wherein the controller operates the first information from the first account, and
the controller operates the second information from the first account.

13. The financial asset management system of claim 12,
wherein the first information at least includes first deposit information concerning money deposited in the first account, input/output history in the first account, a fund name of a selected fund, money information concerning money to be transferred to the fund, processing history information processed by the controller, verification information to be used by a verification unit, and second account information to specify the second account being connected to the first account,
the second information at least includes second deposit information concerning money deposited in the second account, processing history information processed by the controller, fund information concerning the selected fund, and first account information to specify the first account being connected to the second account, and
the controller transfers any of money exceeding an upper limit amount stored in the first information and money reaching an accumulation target account, out of money deposited in the first account toward the second account, based on the name of the selected fund and the money information which are included in the first information.

14. The financial asset management system of claim 6,
wherein the client terminal is a computer capable of accessing the financial asset management system via the network.
